(19) United States
(12) Patent Application Publication
(10) Pub. No.: US 2008/0235026 A1
(43) Pub. Date: Sep. 25, 2008

(54) VOICE ACTIVATED DISTANCE MEASURING DEVICE

(76) Inventors: Reginald G. Garratt, Chicago, IL (US); Gail Garratt, Chicago, IL (US); Sean R. Garratt, Schaumburg, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 12/026,395

(22) Filed: Feb. 5, 2008

Related U.S. Application Data
(60) Provisional application No. 60/888,194, filed on Feb. 5, 2007.

(51) Int. Cl. G10L 11/00

(52) U.S. Cl. 704/270; 704/E11.001

(57) ABSTRACT

A voice activated device for annunciating a message indicative of a distance of the device spaced from another location is disclosed. The device comprises a voice sensor for receiving a voice command requesting annunciation of a message indicative of the distance of the device spaced from the other location, converting circuitry coupled to the voice sensor for converting the received voice command to a corresponding electrical command, determining circuitry responsive to the electrical command for determining the distance of the device from the other location, and a speaker coupled to the determining circuitry for annunciating the message indicative of the determined distance of the device from the other location. The device may be used for informing a golfer of the golfer's distance from the pin.

### CROSS-REFERENCE TO RELATED APPLICATION

This patent claims the benefit of U.S. Provisional Patent Application No. 60/888,194, filed Feb. 5, 2007. This patent further claims the benefit of U.S. patent application Ser. No. 11/417,740, filed May 4, 2006, which claims the benefits of U.S. Provisional Patent Application No. 60/679,525, filed May 10, 2005 and U.S. Provisional Patent Application No. 60/756,259, filed Jan. 4, 2006.

### TECHNICAL FIELD

This patent generally relates to a voice activated distance measuring device, such as for providing distance and other information to a golfer.

### BACKGROUND OF THE INVENTION

Range finding devices, such as the SkyCaddie range finder sold by Skyhawke Technologies, LLC (see www.skygolfgps.com), are known and provide information to golfers, such as the distance from a golfer's current location to a golf pin. However such devices require manual requests for information and provide only visual display of the requested information, which can be cumbersome to the golfers.

### BRIEF DESCRIPTION OF THE DRAWINGS

For a more complete understanding of this disclosure, reference should be made to the following detailed description and accompanying drawings wherein:

FIG. 1 is a block diagram of a voice activated distance measuring device in accordance with the invention;

FIGS. 2A-2B illustrate perspective views of a voice activated distance measuring device that may be utilized in various types of devices according to various embodiments of the invention;

FIG. 3 illustrates an aerial view of a representative golf course;

FIG. 4 illustrates a flow diagram of a process for golf course data file search and load of one embodiment of the invention;

FIG. 5 illustrates a golf course distance calculation program of one embodiment of the invention;

FIG. 6 illustrates a flow diagram of a process using voice recognition/navigation technology of one embodiment of the invention; and

FIGS. 7A-7B illustrate representative views of a golf course using a cone calculation of one embodiment of the invention.

### DETAILED DESCRIPTION OF THE INVENTION

While this invention is susceptible of embodiment in many different forms, there will be described herein in detail, specific embodiments thereof with the understanding that the present disclosure is to be considered as an exemplification of the principles of the invention and is not intended to limit the invention to the specific embodiments illustrated.

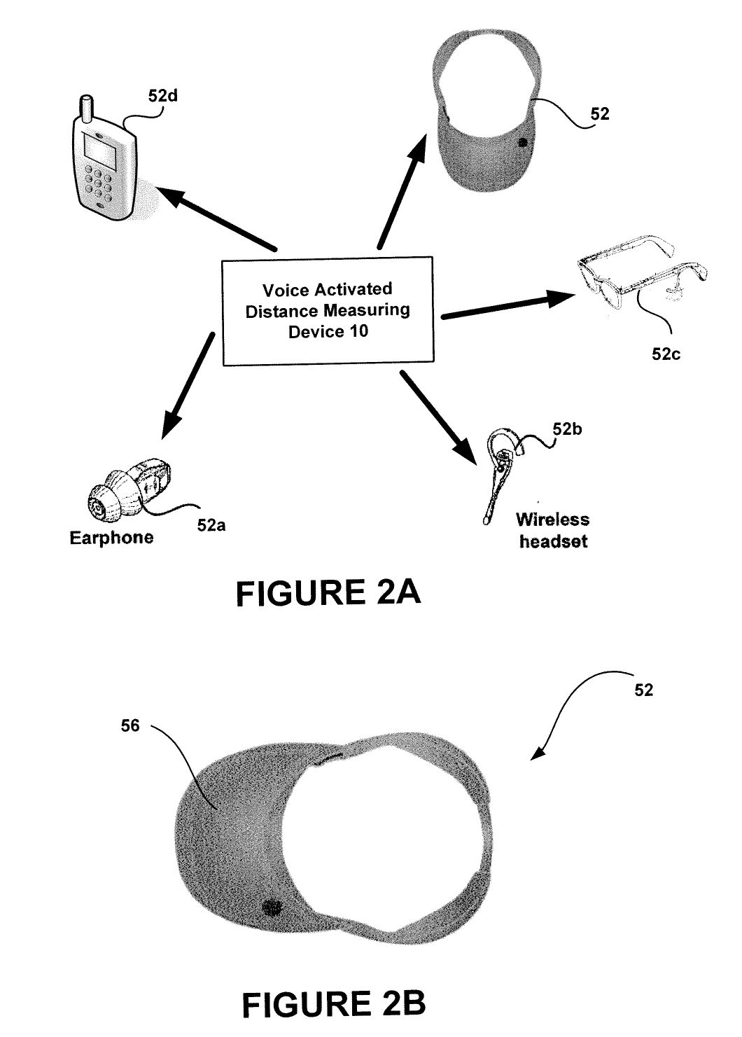

Embodiments directed to a voice activated distance measuring device 10 that measures distances on a golf course and provides other relevant information are illustrated in the following figures. The device 10 may be useful for other applications, as well. The device 10 may use voice recognition/navigation technology and Global Positioning System (GPS) technology to provide a user, such as a golfer, with required data on the golf course and its parameters in a verbal electronically spoken form. As illustrated in FIG. 2A, the device 10 may be incorporated into any type of body-worn device, such as a hat 52, an earphone 52a, a cellular phone 52d, an eye-glass 52c, a headset 52b, or the like. The device 10 may alternatively use distance measuring technology such as infrared (IR), optics, Doppler acoustics and the like.

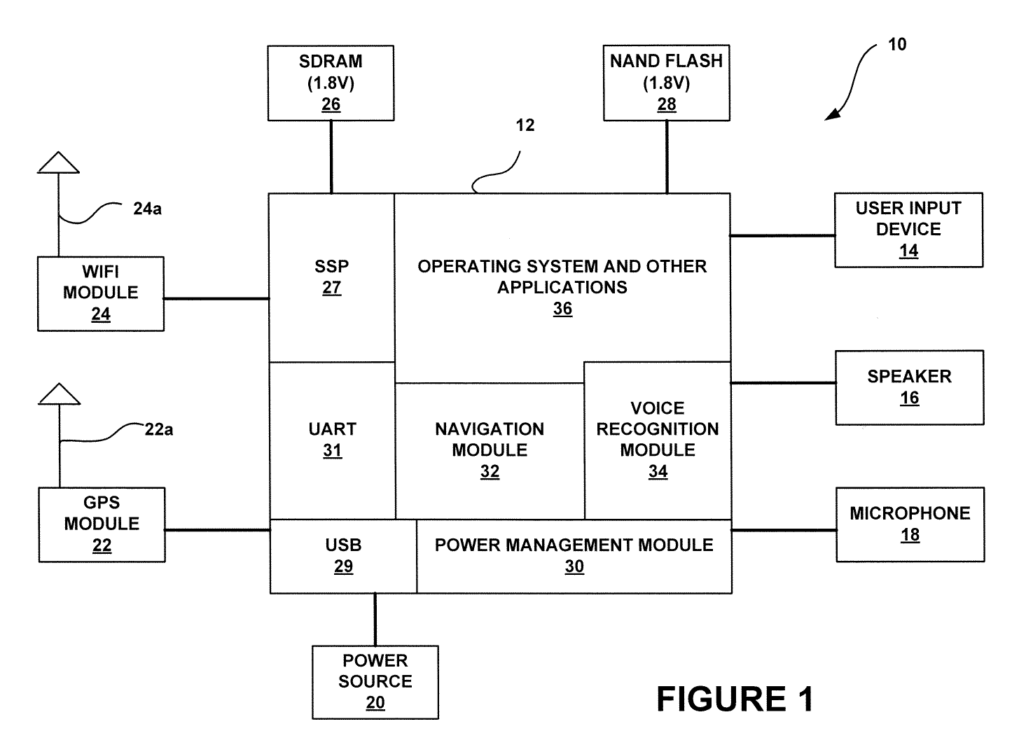

Referring to FIG. 1, the device 10 may include a microprocessor 12, such as model no. AS 3527 supplied by Austria Microsystem. The device 10 further includes a user input device 14, a speaker 16, a transducer 18, a power source 20, a GPS module 22, a Wi-Fi module 24, first and second antennas 22a, 24b, and memory modules 26, 28 coupled to the microprocessor 12. The first antenna 22a is coupled to the GPS module 22, and the second antenna 24b is coupled to the Wi-Fi module 24. The microprocessor 12 may include a synchronous serial port (SSP) 27, a universal asynchronous receiver/transmitter (UART) 31, a user serial bus (USB) 29, a power management module 30, a navigation module 32, a voice recognition module 34, and other operating systems and applications 36. An optional VoIP stack module (not shown), or the like may be provided in the device 10 to perform certain operations.

The device 10 may incorporate voice recognition technology to accept voice commands from the user which are sensed by the transducer 18, such as a bone conductance vibration sensor or a microphone, which drives the voice recognition module 34. If the bone conductance vibration sensor 18 is used, the sensor may receive audio from the user directly from vibrations conducted through the skull of the user by direct mechanical contact of the sensor 18 to the user's forehead. The device 10 may respond to voice commands or queries such as “distance,” or any other such word or words. Commands may also be in the form of an electrical signal from a switch or any electrical pulse generated by touch or remote control.

The device 10 may incorporate voice synthesis technology to provide an audible output by electronically produced spoken words, to provide distance and other information to the user via the speaker 16 or a listening device such as the headphone 52b, following a command from the user. The output acoustics may be adjusted for volume level and frequency filtered for any particular user requirement or application. The device 10 may also provide in a verbal form possible targets such as green size, bunker location, and other information on the golf course parameters.

The device 10 may also accept commands, store the commands and compute the commands, when prompted by the voice command or the electrical pulse generated by touch or remote control, to suggest user golf strategy, club selection, rules and other golf player needs. For example the user may verbally enter information, either directly or by a verbal prompt, such as the club selected for the shot. In the course of play to mark the ball location to determine the distance to a target or various objects, e.g. a bunker, or water, the GPS technology integrated in the device 10 may determine the actual distance traveled by the ball and its accuracy. Such distance is computed by the navigation module 32, processes the data representing the distance before the data is transferred to the voice recognition module 34. The voice recognition module 34 may convert the transferred data into an audible output before transmitting to the user. Information regarding weather conditions, such as wind speed and wind direction, may also be provided. Over time the device 10 may build a library of information regarding the golfer's personal shot results, such as how far does a ball typically travel, and how accurately, when hit with each club. The device 10 may calculate and memorize this information and function as an expert system to progressively learn the golfer's successes and failures to generate a strategic recommendation which may also be based on an algorithm which may be developed for this system. This information may be used to provide the golfer with recommendations for future golf shots based on the golfer's past performance.

The golfer may enter any metric including swing speed, ball flight path, shot distance, swing path, ball speed, etc, to a separate personal computer using a user input device, such as a keyboard, etc, prior to initiating the device 10. The golfer's personal profile, such as sex, age, skill level, etc, may be entered to the computer. The computer may include a commercially available computer based program to provide a visual graph. The graph may represent information including the input metric and the golfer's personal profile. The graph is stored in a database and may be adjusted automatically or manually at any later time, as desired. The pre-recorded information including the graph is then loaded to the device 10. The golfer may then elect to record each activity including golfer's scores, golf swing, ball distance, ball locations at each shot execution, the club used at each shot execution, ball fight trajectory, and so on, during the course of the play on the device 10. For example the golfer may say “mark ball” and the device 10 may record position/date/time and all pertinent information known to the device 10. In another example the golfer may say “mark ball using nine iron” and the device 10 may record the club (i.e. nine iron) used based on the command provided by the golfer. Each recorded data associated with a new date and/or time is stored in a database or a library of the device 10. Additional data may be added or updated to the library. The device 10 may continually adjust the graph based on recorded data taken on the field performance. In doing so, the device 10 may progressively learn the golfer's successes and failures based on the pre-recorded information and the recorded field data to generate strategic recommendations. Other information such as weather and/or environmental conditions may be recorded on the device 10 to provide the golfer with recommendations for future golf shots based on the golfer's past performance.

A golf club professional and/or the golfer may download the library from the device 10 to the computer and analyze results of the golfer's game, or many games. A bird's eye view of the golf course including information, such as ball landing positions, etc and a table associating with the scores, plotting game club used may be provided to facilitate the golfer to improve future plays based on the past performance, may be displayed on the computer screen. The golf club professional or the golfer may then voice record the golf tips or advice for the golfer in situations where the professional knows the golfer requires improvement and help. This “help command,” recording could equally follow a lesson.

In addition, the device 10 may also provide pre-recorded golf instructions to assist the golfer in making a specified golf shot, when prompted to do so by a voice recognition command or an electrical pulse generated by touch or remote control.

The help command may be personalized. For example the golfer may say “Help,” and the device may reply, “Hi Joe, how can I help you.” The golfer may state a command relating to his difficulty, for example “downhill lie” or simply “my swing.” This may trigger the professional's recording to say. “Joe, what I want you to do is,” to be followed by customized advice.

This aspect of teaching provides a financial incentive for the professional to carry the device 10 in the pro-shop and permit the professional to charge for the analysis and recording. This would provide the professional with income in the following manner. (1) The profit on selling the device 10 in the first place. (2) Transferring the embedded computer from one device to a different device after proper instruction. And (3), charging for recording the “help” advice into the memory of the device 10. This provides an ongoing stream of income as a strong incentive to sell the device 10, plus the likelihood that the trainee's game score will improve.

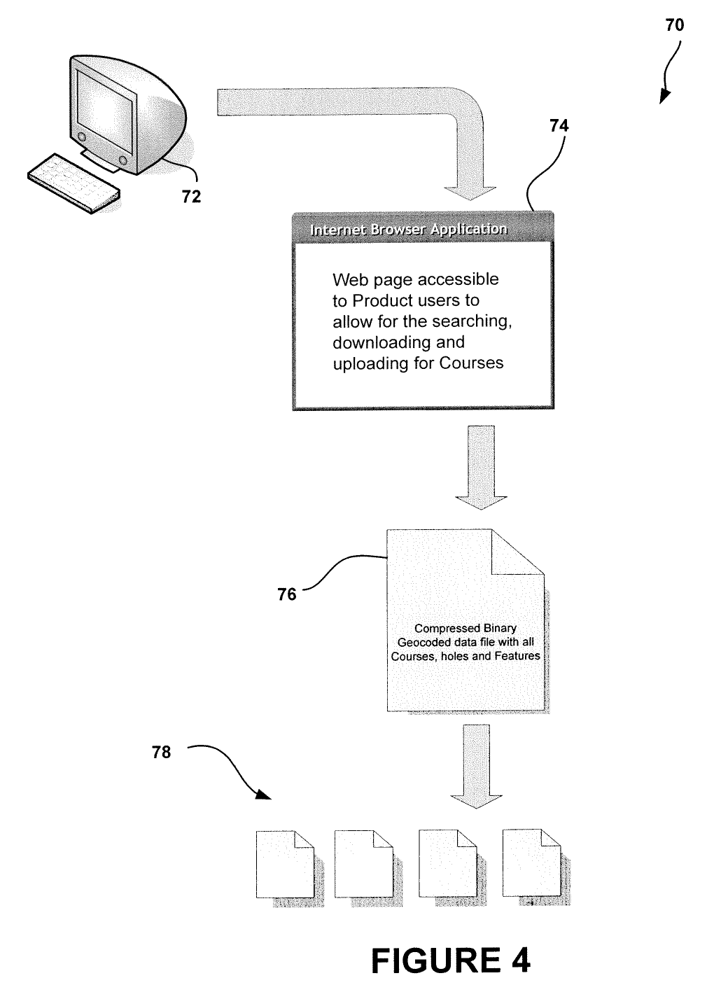

Referring to FIG. 4, more than one file 64 containing different golf courses 78 may be stored in a database for searching, transferring and/or downloading to the device 10 by one or more users. The user may initiate communications with a website server via an internet 74 or other user accessible network using a separate personal computer 72 or other appropriate computing machine. During the course of play, the appropriate course 78 stored in the file 64 may be automatically loaded by a device program of the device 10 on start mode, by determining the golfer's current position and finding any loaded course which may intersect with the golfer's current position and loading the appropriate course 78.

The device 10 may be used for such applications as hiking, surveyors and hunters and other applications. The device may also be used for scuba divers using an underwater design which may use any latitude and longitude measurement technology.

The device 10 may be expanded to include its use in any portable application such as a PDA, cellular phone, Bluetooth headset, or the like.

The device 10 may be provided with a communications method, such as but not limited to, a serial, USB or wireless connection to a separate personal computer or similar technology provided by the user of this device 10. The device 10 may be able to upload and download data to a separate computer to facilitate various detailed functions, if such functions are beyond the scope of the device 10 by itself such as, but not limited to, graphical display of the users score and plot of all ball trajectories viewed against an image of the subject golf course, display of clubs used, comparative display of any other player or players using the system, expert system advice based on data accrued during one or more recorded games, printing of results and scorecards. The connection may also facilitate uploading of new course databases to the device 10 and management thereof, training of voice recognition commands and management of those commands.

Referring now to FIG. 1, as discussed above, the device 10 may include the microprocessor 12, the user input device 14, the speaker 16, the microphone 18, the power source 20, the GPS module 22, the Wi-Fi module 24, first and second antennas 22a, 24b, and memory modules 26, 28 coupled to the microprocessor 12. The first antenna 22a is coupled to the GPS module 22, and the second antenna 24a is coupled to the Wi-Fi module 24. The memory module 26 may be a 1.8 volt SDRAM and the memory module 28 may be a 1.8 volt NAND flash memory. The microprocessor 12 may include the synchronous serial port (SSP) 27, the universal asynchronous receiver/transmitter (UART) 31, the user serial bus (USB) 29, the power management module 30, the navigation module 32, the voice recognition module 34, and other operating systems and applications 36. The device 10 may be configured to transmit and receive wireless communication in accordance with any suitable protocol such as Bluetooth, Ultra-wideband (UWB), Home Radio Frequency (HomeRF), Digital Enhanced Cordless Telephone (DECT), Personal Handy System (PHS), wireless LAN (WLAN), and other open or proprietary protocols that are capable to communicatively couple between the device 10 and/or an external device (not shown). Wireless installation of golf course data or program updates via any suitable protocol as described above will allow such conveniences as allowing the golfer to upload golf course GPS coordinate data while in the pro shop or retail outlet without needing a wired connection or even removing the hat device from his/her head. This will facilitate and encourage users to purchase golf course files.

Bluetooth technology, a known and published radio frequency short range data/audio transfer technology, may be used in the device 10 for at least five primary purposes, data transfers, as an audio server, as an audio client, short range audio communications and as a remote GPS. As a Bluetooth audio server, it will be possible for the user to use a separate Bluetooth headset of the type used often in cell phones to access the voice recognition input and audio output of the device 10, without using the built in speaker/microphone. This would enable the user to use the device 10 even if the hat were not worn, or indeed if the device 10 were not in a hat at all, and was implemented as any other form of a wearable computer not requiring a built in speaker/microphone. As a Bluetooth audio client, the hat device's speaker/voice sensor could be used for an auxiliary headset for another Bluetooth audio server such as a cell phone, in the same manner a Bluetooth ear clip headset is currently used. As a short range audio communications client, it would be possible for two users of the device 10 to maintain wireless audio communications providing they were in range typical of Bluetooth devices, usually 100 m maximum. As a remote GPS, it would be possible for a user to use the GPS module 22 contained in the device 10 with another program which required a GPS by transmitting the coordinate data over the Bluetooth using known Bluetooth protocols for GPS data transmission.

The power source 20 may be coupled to the rest of the components including the microprocessor 12, the speaker 16, and the microphone 18 to power the device 10. While the power source 20 may be a 5 volt Lithium-Ion battery, other types of batteries may be possible. Optionally, a connector (not shown) may be provided to recharge the battery 20. Alternatively, a solar panel (not shown) may be provided to power the device and/or to charge the battery 20. The antennas 22a, 24b may be used to transmit and receive signals between the memory modules 22, 24 and an external source (not shown). The antennas 22a, 24a may be external or internal to the respective memory modules 22, 24. The antennas 22a, 24a may serve as part of the communication link. The user input device 14 may be a button switch to facilitate multi-functions for the device 10, such as power on/off switch, volume control, or the like. The microphone 18 picks up acoustic input as heard in the environment or bone conductance via the skull and converts the signal into a corresponding electrical. The microphone 18 may be a silicon condenser microphone, an electret microphone, a dynamic microphone, or the like, depending on the desired applications. The receiver 16 converts the electrical signal to an acoustic sound before transmitting the acoustic sound to the user. The speaker 16 may be a balanced armature receiver, a moving coil receiver, or the like.

The voice recognition module 34 is a software program commercially available from Sensory, Inc, and capable of speech or voice recognition. Other suitable types of voice or speech recognition processors may be used. Further, the voice recognition module 34 may store voice recognition information and a set of command including menu grammar and/or common command grammar for expanding the vocabulary. The power management module 30 may monitor the status of the power consumption. At least one application-specific program may be generated using the navigation module 32. More details about the application-specific software program are described below.

FIGS. 2A-2B illustrate the flexibility and usefulness of the device 10 to be fitted virtually in any type of body-worn device, such as a hat 52, an earphone 52a, a cellular phone 52d, an eye-glass 52c, a wireless headset 52b, or the like. As shown in FIG. 2B, the device 10 may be disposed in a clamshell type housing (not shown). The housing may then be fitted in a brim 56 of the hat 52. The housing provides protection to the device 10 from environmental and/or other external damage. The housing may be made of a plastic material and may be removably fitted to other wearing device. Other types of material are possible. While the housing 54 may be curved to the shape of the brim 56, it will be understood that any housing shape or configuration suitable for a desired application may suffice, including a roughly square shape, a rectangular shape or any other desired geometry and size. The device 10 may be placed at different locations of the brim 56. For example, the device 10 may be located at the middle of the brim. In another example, the device 10 may be located on left or right side of the brim.

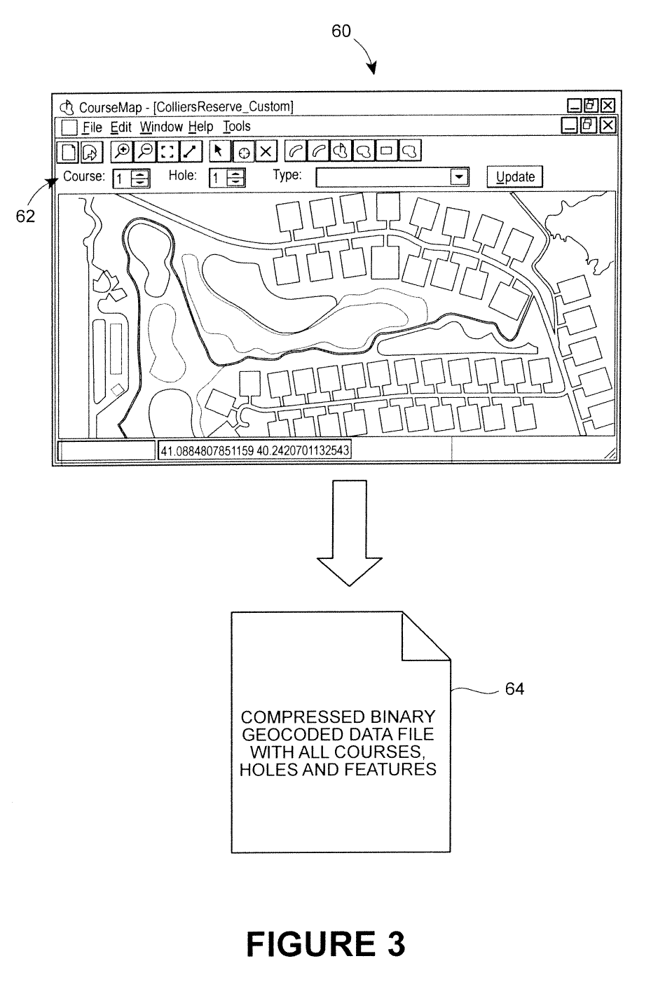

FIG. 3 illustrates an aerial view of a representative golf course displayed on a computer screen. A golf course data formatting process may be provided by an application software vendor to digitize a commercially available GPS golf course 60 containing the golf course data, such as supplied by Sports Mapping, Inc., or similar company before uploaded to the device 10 by the user. The process may include processing the golf course map data, removing certain golf course data from the map that may not be required in computing or measuring the full depth of the golf course, and then converting/mapping GPS mapped longitude and latitude coordinates to measure distance and possible targets that may come into play. In the process of recording the course, the vendor may follow the contours of the golf course 60 and may indicate the latitude and longitude using three reference points within the entire golf course 60. The latitude and longitude coordinates of these reference points are obtained by physically going to these points on the actual golf course and utilizing GPS technology to determine their precise locations. Once the locations of the reference points are determined, the latitude and longitude of all subsequently mapped points are calculated. The vendor may visually identify the object, such as a fairway, bunker, green, etc of each hole and may select the correct attributes from a toolbar 62, such as hole number and then clicks points around the circumference of each hole detailing its perimeter. Other information, such as the name of the golf course, or distance, etc, may be contained in the toolbar 62. The process may be repeated until all holes of the course are mapped. The golf course data and information may be stored in a file 64 having a compressed binary machine independent format capable of being opened and read by any operating system. The stored file 64 using point/vector outline of a golf course is extremely compact and easily navigable to quickly find the objects, in particular, containing multiple latitude/longitude points described above, within various regions of the golf course. While this process is done on initial program load, it will be understood that the process may be done again at a later time to update the golf course data and information previously obtained by surveying of the golf course. Once the data is stored in the file 64, the file 64 is now ready to be uploaded to the device 10 by the user. The user via a user browser may access a vendor network server via a vendor network. The network server is, in turn, connected to a vendor application server that enables integration of a file database having information such as the golf course data file 64.

Alternatively, the golf course recording process may be designed in such a way as to allow the average person who is not necessarily an expert in computer or GPS technologies an easy method to record a golf course that the user may wish to record, and allow for that course recording to be electronically transmitted to others for the purposes of sharing recorded courses and building up a shared collection of recorded courses. Upon completion of the recording of course features, the completed file containing multiple instance recordings of course name, hole number, hole feature and geographic location may be used to facilitate the calculation of geographic distances between the golfer's current GPS position and those features, such as but not limited to the distance from the golfer to the center of the green. Other course feature recordings may be used also in the process of giving the golfer advice, by relating his/her current geographic position to those features. The recorded course data may also be used for other purposes, such as but not limited to information for greens keepers to assist in course maintenance or the production of maps or computer models.

FIG. 4 illustrates a flow diagram of a process for golf course data file search and upload 70 of one embodiment of the invention. As described above, the user may initiate communications with a website server via an internet 74 or other user accessible network using a computer 72 or other appropriate computing machine. The golf course stored in the file 64 may be uploaded to the computer 72 within an associated database, accessible via the internet 74. The file 64 may be downloaded or transferred directly to the device 10 via a USB, firewire, or by wireless connection such as 802.11 WiFi or Bluetooth. More than one file 64 containing different golf courses 78 may be stored in the database for searching, transferring and/or downloading to the device 10 by one or more users. During the course of play, the appropriate course 78 stored in the file 64 may be automatically loaded by a device program of the device 10 on start mode, by determining the golfer's current position, e.g. latitude/longitude, and finding any loaded course which may intersect with the golfer's current position and loading the appropriate course 78.

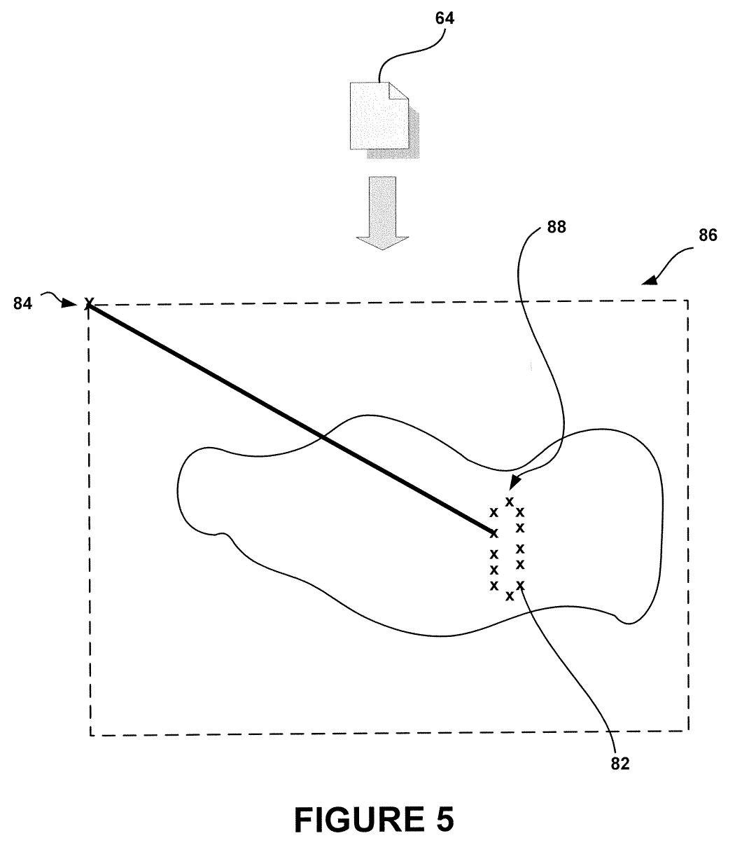

FIG. 5 illustrates a golf course distance calculation program. The golf course distance calculation program is an application-specific program run by the navigation module 32. Generally, the golf course distance calculation depends on accurate calculations of distance between any two given points. Existing algorithms calculate distances using Vincenty Algorithm or Great Circle Algorithm. However such algorithms require high power consumption and often a complicated floating point calculation is required in order to calculate the distances from the golfer's current position to an object, e.g. bunker, green, etc. A software application using a reduced processor power may be preferred by a handheld device or wearable lightweight low power device. In one embodiment, the file 64 containing the appropriate course 78 may be initiated for loading. As shown, a number of latitude/longitude points 82 on a portion of the golf course 86 are illustrated. The points 82 define the contour of an object, such as water hazard. The points 82 contained in the file 64 may be determined relative to a point 84 located at the most northern and most western points of the golf course. This point 84 may be regarded as an origin of a Cartesian plot of points of the golf course. Once the origin 84 is determined, the distance calculation is performed using a Pythagorean Right triangle by connecting the origin 84 to each point 82. The resultant position for each point 82 may be stored as a Cartesian position relative to the origin 84. Since the distance calculation of all points is performed only once by the navigation module 32 of the device 10, the average processor load and power consumption is reduced to the minimum.

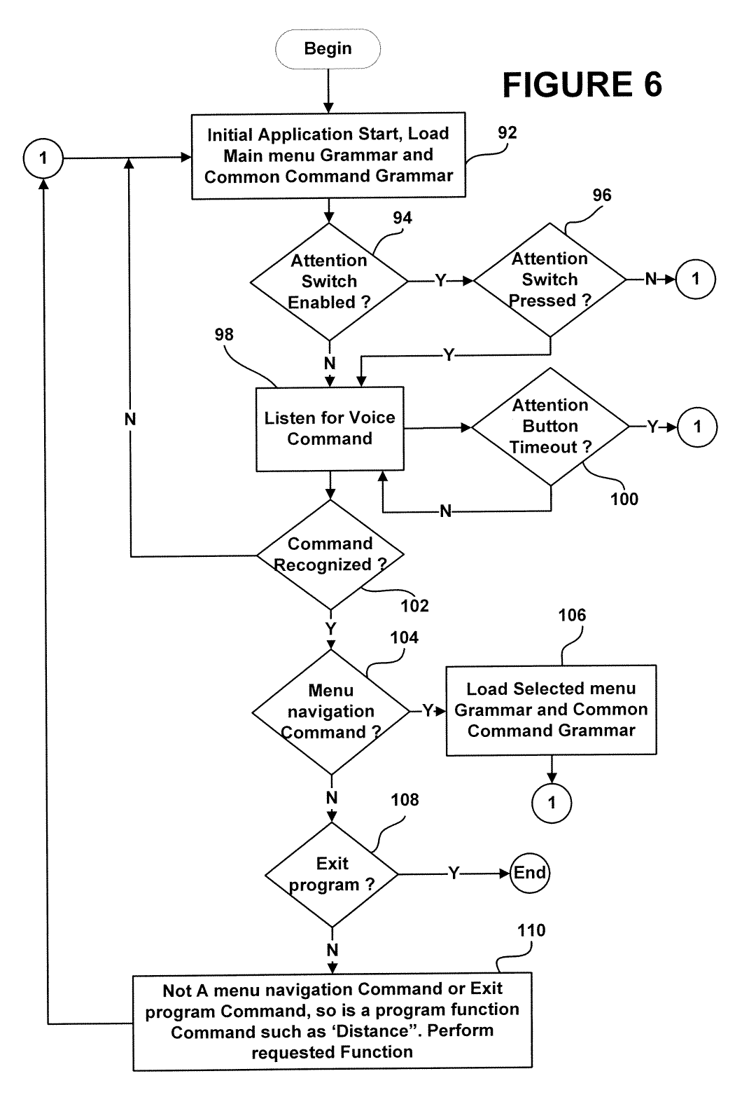

FIG. 6 is a flow diagram showing a process using voice navigation initiated by a user of one embodiment of the invention. The voice recognition application may be stored in the voice recognition module 34 (See FIG. 1) to accept voice commands from the user which are picked up by the microphone 18 (See FIG. 1). The process starts in step 92 which activates the voice activated distance measuring device 10 initiated by the user to load a main menu grammar and/or common command grammar. In step 94, a determination is made as to whether a control switch 14 (See FIG. 1) is enabled and, if not, the process goes to step 98 to receive a voice command. Otherwise, the process goes to step 96 to determine if the control switch 14 is pressed and if not, the process returns to step 94. If the control switch 14 is pressed, the process will proceed to step 98 to receive the voice command. In step 100, a determination is made as to whether a button timeout is expired and, if not, the process returns to step 98. Otherwise, the process returns to step 94. A determination is prompted in step 102 to initiate the voice recognition. If it is affirmative, the process goes to step 104, otherwise, the process returns to step 94. Once the voice command is accepted, a determination is made in step 104 as to whether a menu navigation command should be generated. The menu navigation command may contain a set of command including menu grammar and/or common command grammar. The menu navigation command may be stored in the voice recognition mode 34 (See FIG. 1). If affirmative, the process goes to step 106 where a selected menu grammar and common command grammar is loaded. Otherwise, the process proceeds to step 108, where a determination is made whether to exit or end the program and if not, the process goes to step 110 to perform one or more functions requested by the user. Once the function is performed in step 110, the process returns to step 94.

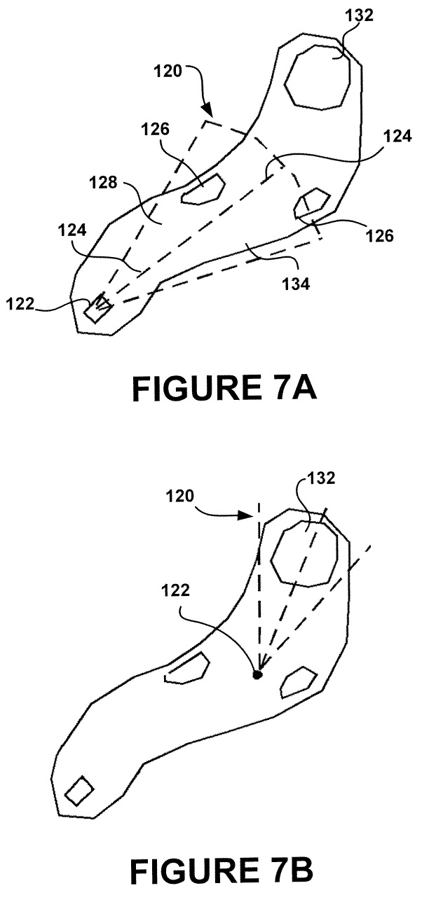

FIGS. 7A-7B illustrate representative views of a golf course using a cone calculation to compute the distance from the ball mark to possible objects that may come into play. The cone calculation may be generated by the navigation module 32 (See FIG. 1). The device 10 using the cone calculation has the ability to zoom into a region/cone of interest projected forward from the user's current position 122 to the user's hitting capability. Once the region of interest 120 is located, the cone calculation enables one to measure the distance from the user's current position 122 to possible targets falling within this region of interest 120 and reports the distance in a verbal form. Since the device 10 does not use a visual display, voice commands and golf course data and information are reported by audio speech. To reduce confusion and complexity of voice menus, it is preferable to reduce the number of objects that are eligible for distance reporting. This may be accomplished by using the device 10 projected forward from the user's current position 122 or ball mark, centered on a fairway midline 124 and having a distance proportionate to the golfer maximum hitting capability, defining a cone of interest 120. Only certain objects 126 falling within the cone are reported. Alternatively, the user may request certain objects 126 falling on left 128, right 134, or the midline of the cone of interest 120 be reported by using appropriate voice commands. For example the user may say “distance bunker left” and such command may trigger the device 10 to report the distance to the bunker 16 falling on the left 128 of the cone of interest 120. As another example, the user may say “distance all” and such command may trigger the device 10 to report the distance to all object 126 falling within the entire cone of interest 120. As the golfer moves forward or closer to a target 132, e.g. green, the cone of interest 120 moves forward with the golfer 122. Once the green 132 is within the range of the cone 120, green center may be used to calculate midline position instead of fairway midline 124.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. A body-worn device comprising:
a voice activated distance measuring device including:
a voice recognition module for receiving a voice command requesting annunciation of a message indicative of a distance from the device to a feature, converting the received command to a corresponding electrical command, and outputting the message indicative of the determined distance of the device from the feature; and
a navigation module for locating the feature within a region of interest and measuring the distance from the feature.

2. The device of claim 1, wherein the navigation module and the voice recognition module are incorporated in a microprocessor.

3. The device of claim 2, wherein the device is powered by a power source.

4. The device of claim 3, wherein the power source is a battery or a solar panel.

5. The device of claim 1, further comprising a transducer coupled to the device.

6. The device of claim 5, wherein the transducer is a microphone, a receiver, or both microphone and receiver.

7. The device of claim 6, wherein the microphone is a silicon condenser microphone, an electret microphone, a bone conductance vibration sensor, or a dynamic microphone.

8. The body-worn device of claim 6, wherein the speaker is a balanced armature receiver or a moving coil receiver.

9. The device of claim 1, wherein the body-worn device is a hat, a visor, a PDA, a cellular phone, a headphone, a earphone, an eye-glass, or a wireless headset.

10. The device of claim 1, wherein the voice activated distance measuring device utilizes at least one of Bluetooth technology, Ultra-wideband technology, Home Radio Frequency technology, wireless LAN, infrared technology, optical measuring technology, Doppler acoustical distance measuring technology, or GPS technology.

11. The device of claim 2, wherein the navigation module is a processor capable of calculating the distance from the feature using a Pythagorean right triangle theorem.

12. A method of formatting a golf course map comprising:
digitalizing a GPS golf course map containing a plurality of features;
selecting a first set of three reference points on the golf course;
determining the coordinates of the three reference points;
mapping the course by identifying the features of the golf course relative to the three determined reference points; and
storing the formatted course.

13. A voice activated device for annunciating a message indicative of a distance of the device relative to a feature of a golf course, the device comprising:
a speaker;
a microphone; and
a microprocessor including a voice recognition module for receiving a voice command requesting annunciation of a message indicative of a distance from the device to a feature, converting the received command to a corresponding electrical command, and outputting the message indicative of the determined distance of the device from the feature and a navigation module for locating the feature within a region of interest and measuring the distance from the feature;
wherein the speaker and the microphone are coupled to the microprocessor.

14. The device of claim 13, wherein the device is disposed in a hat, a visor, a PDA, a cellular phone, a headphone, a earphone, an eye-glass, or a wireless headset.

15. The device of claim 13, wherein data indicative of the distance from the feature is pre-calculated using a Pythagorean right triangle theorem.

16. A method for calculating a distance from a feature on a golf course comprising:
determining at least two graphical coordinates of the golf course including a first coordinate and a second coordinate;
connecting the first and second coordinates, defining a data; and
computing the data indicative a distance from a feature using a Pythagorean right triangle theorem.

17. The method of claim 16, wherein the first coordinate is an origin and the second coordinate is a point of the feature.

18. The method of claim 17, wherein the feature is contoured by a plurality of points.

19. A method for providing a golfer with information regarding a distance from a feature comprising:
projecting a cone of interest forward from a golfer current location;
determining if a feature falls within the cone of interest; and
voice reporting if the feature is determined to fall within the cone of interest.

20. The method of claim 19, wherein the cone of interest includes one of left portion, right portion, or midline of the cone of interest.
